(19) United States
(12) Patent Application Publication
(10) Pub. No.: US 2010/0282013 A1
(43) Pub. Date: Nov. 11, 2010

(54) LUBRICATION STRUCTURE OF GEAR TRAIN ENCASED IN GEAR CASE

(75) Inventors: Akihiko Fujimoto, Sagamihara-shi (JP); Kazunari Okabe, Sagamihara-shi (JP)

Correspondence Address: BIRCH STEWART KOLASCH & BIRCH, PO BOX 747, FALLS CHURCH, VA, 22040-0747, US

(73) Assignee: Mitsubishi Heavy Industries, Ltd., Tokyo (JP)

(21) Appl. No.: 12/681,585

(22) PCT Filed: Mar. 17, 2009
(86) PCT No.: PCT/JP2009/055727

§ 371 Date: Jun. 21, 2010

(30) Foreign Application Priority Data
Mar. 28, 2008 (JP) 2008-088109

(51) Int. Cl. F16H 57/04

(52) U.S. Cl. 74/467

(57) ABSTRACT

In a gear train in which a gear case encases a first gear meshing with a second gear having a diameter smaller than that of the first gear, a sufficient amount of lubricant is normally supplied to the upper second gear. As a result, it is possible to provide a lubrication structure of a gear train encased in a gear case designed to prevent occurrence of problems such as poor lubrication and seizure of a gear train. In a lubrication structure inside a gear case having a configuration in which the gear case encases the first gear meshing with the second gear having the diameter smaller than that of the first gear, and the first gear is disposed so as to have a minute gap between the gear case and an outer diameter of the first gear, oil inside an oil chamber below the first gear is pumped up with a movement of gear teeth forming a minute gap by a rotation of the first gear; the pumped oil is discharged into a space above the first gear and inside the gear case; the pumped oil is received by an oil receiver provided in the upper portion of the second gear and including a rib for receiving the pumped oil and a recess surrounded by the rib; and then the oil is supplied to lubricate a gear tooth portion and a bearing portion of the second gear.

### TECHNICAL FIELD

The present invention relates to a lubrication structure of a gear train encased in a gear case applied to a transfer drive device of a battery-powered forklift and the like, and particularly, to a lubrication structure of a gear train in which the gear case encases a first gear meshing with a second gear having a diameter larger than that of the first gear.

### BACKGROUND ART

FIGS. 1 and 2 are partial configuration diagrams showing a transfer drive device according to embodiments of the invention, where FIG. 1 is a schematic side view showing a transfer drive device (a decelerator interposed between a drive motor and a vehicle wheel) of a battery-powered forklift, and FIG. 2 is a sectional view taken along the line A-A in FIG. 1 (these are embodiments of the invention, but the generally known points will be described first).

In the transfer drive device of the battery-powered forklift, an output shaft 104 of a motor is fitted to the first stage gear 105 while being faucet-fitted to a hole provided in the gear case 8 of the transfer drive device.

The first stage gear 105 meshes with an intermediate gear 106, and the intermediate gear 106 meshes with a bowl-shaped third stage gear (reduction spur gear) 107 having a large diameter. Accordingly, a first speed reduction of a rotation of the motor is performed.

In addition, in the transfer drive device, as shown in FIG. 1, the upper portion of the first stage gear 105 having an axis 16s meshes with the intermediate gear 106 having an axis 9s, and a third stage gear 107 having an axis 9 meshes with the lower portion of the intermediate gear 106.

Accordingly, in the transfer drive device, the lubrication of the first stage gear 105, the intermediate gear 106, the third stage gear 107, and the bearing portion 107D is performed by an oil splash feeding operation of oil collected in the lower portion inside the gear case 8.

In addition, Patent Document 1 (Japanese Patent Application Laid-Open No. 2006-70912) discloses a technology for a lubrication structure of a transmission unit. That is, in a differential gear box constituting a transmission, there are provided a bearing member rotatably supported to the gear box, a lubricant pipe provided between a rotary shaft of the gear box and another rotary shaft so as to supply lubricant therebetween, and a rib-shaped pedestal formed in a housing so as to guide lubricant to the bearing member and to fix the lubricant pipe.

When the lubrication structure of the transmission unit is applied to the transfer drive device of the battery-powered forklift, as shown in FIG. 1, in the case of the structure in which the intermediate gear 106 having the axis 9s meshes with the first gear 105 having the axis 16s and the third stage gear 107 having the axis 9 meshes therewith, the axis 9s of the intermediate gear 106 is located above the axis 9 of the third stage gear 107. Accordingly, particularly, as shown in FIG. 1, in the case where the third stage gear 107 rotates in the right direction, oil inside the gear case 8 of the transfer drive device is difficult to bring directly into contact with the bearing portion 107D and the intermediate gear 106 located at the upper position, and hence the oil supply state is poor. For this reason, a countermeasure to the poor oil supply state has been demanded.

### SUMMARY OF THE INVENTION

The present invention is contrived in consideration of the above-described problems of the background art, and an object of the invention is to provide a lubrication structure of a gear train encased in a gear case designed to prevent occurrence of problems such as poor lubrication and seizure of a bearing portion and a gear train in such a manner that a first gear is provided, a second gear is provided above the first gear in a direction perpendicular to an axis of the first gear and has a diameter smaller than that of the first gear, a gear train is obtained by the gears meshing with each other as in the gear case of the transfer drive device, and then a sufficient amount of lubricant is normally supplied to the upper second gear.

In order to achieve the above-described object of the invention, there is provided a lubrication structure of a gear train encased in a gear case, including: a first gear; a second gear which is disposed above the first gear in a direction perpendicular to an axis of the first gear (vertical direction) and has a diameter smaller than that of the first gear; and the gear case which encases the gear train of the first and second gears meshing with each other, wherein the first gear is disposed so as to have a minute gap between the gear case and an outer diameter of the first gear, oil inside an oil chamber below the first gear is pumped up with a movement of gear teeth forming the minute gap by a rotation of the first gear, and the pumped oil is discharged into a space above the first gear and inside the gear case, and wherein an oil receiver for receiving the pumped oil is provided in such a manner that a rib is provided in the upper portion of the second gear to receive the pumped oil, and a recess is surrounded by the rib, and the oil is supplied to lubricate a bearing portion of the second gear.

In the above-described configuration, it is desirable to have the following detailed configuration.

(1) The oil receiver is provided in such a manner that the rib is enlarged into plural ribs in a radial shape, and the recess is provided between the plural ribs (desirably, a pair of ribs).

(2) A vertical height L2 of the oil receiver from an axis of the first gear is set to be smaller than a radius L1 of the first gear.

(3) A second oil receiver is provided in such a manner that plural (desirably, two) bosses are provided in the upper portion of the bearing portion of the second gear, and a recess is provided between the plural bosses, and oil flowing out from the second oil receiver is supplied to the bearing portion.

(4) An inner surface of a second oil receiver on the side of the second gear and a processing surface of an attachment boss of the second gear are formed as a common integral processing surface.

Further, the invention may have the following configuration.

There is provided a lubrication structure of a gear train encased in a gear case, including: a first gear; a second gear which is disposed above the first gear in a direction perpendicular to an axis of the first gear (vertical direction) and has a diameter smaller than that of the first gear; and the gear case which encases the gear train of the first and second gears meshing with each other.

Oil inside an oil chamber below the first gear is pumped up with a movement of gear teeth forming a minute gap by a rotation of the first gear, and the pumped oil is discharged into a space above the first gear and inside the gear case, and wherein the upper portion of the second gear is provided with a contact plate which comes into contact with the pumped oil, and turbulence of the oil inside the gear case is suppressed by the contact plate.

According to the invention, oil inside an oil chamber below the first gear is pumped up with a movement of gear teeth forming a minute gap by a rotation of the first gear, and the pumped oil is discharged into a space above the first gear and inside the gear case, and an oil receiver for receiving the pumped oil is provided in such a manner that a rib is provided in the upper portion of the second gear to receive the pumped oil and a recess is surrounded by the rib.

Accordingly, the oil inside the oil chamber is pumped up with the movement of the gear teeth forming the minute gap of the outer periphery of the first gear by the rotation of the first gear having a large diameter, and is discharged into the upper space inside the gear case due to the centrifugal force by the rotation of the first gear.

In addition, the upper portion of the second gear is provided with the oil receiver including the rib for receiving the pumped oil and the recess formed by the rib. The pumped oil is received in the oil receiver, and is supplied to lubricate the gear tooth portion and the bearing portion of the second gear. That is, the oil is pumped up by the centrifugal force by the rotation of the first gear, the pumped oil is received in the oil receiver provided in the upper portion of the second gear, and then the oil is supplied to lubricate the gear tooth portion of the second gear. Accordingly, it is possible to effectively and economically use the oil. Also, since a sufficient amount of lubricant is supplied to the upper second gear, it is possible to prevent occurrence of problems such as poor lubrication and seizure of the gear train and the bearing portion.

Further, in addition to the oil receiver, two bosses are provided in the upper portion of the bearing portion of the second gear, and the recess of the bosses forms the second oil receiver. Accordingly, it is possible to more reliably and effectively seize the pumped oil by using the oil receiver formed by the recess surrounded by two bosses, and to lubricate the bearing portion by using the oil.

When the vertical height L2 of the oil receiver from the axis of the first gear is set to be smaller than the radius L1 of the first gear, it is possible to smoothly supply the oil pumped by the outer periphery of the first gear to the lower oil receiver.

In addition, when the inner surface of the second oil receiver on the side of the second gear and the processing surface of the attachment boss of the second gear are formed as a common integral processing surface, it is possible to process the inner surface of the oil receiver together with the processing surface of the attachment boss, and thus to simplify the processing operation.

Further, oil inside an oil chamber below the first gear is pumped up with a movement of gear teeth forming a minute gap by a rotation of the first gear, and the pumped oil is discharged into a space above the first gear and inside the gear case. The upper portion of the second gear is provided with a contact plate which comes into contact with the pumped oil, and turbulence of the oil inside the gear case is suppressed by the contact plate. Accordingly, the pumped oil comes into contact with the contact plate. Therefore, the disturbance of the stream is removed, and tiny oil droplets are captured, thereby suppressing the turbulence. Subsequently, the pumped oil is supplied to the second gear.

### BRIEF DESCRIPTION OF THE DRAWINGS

FIG. 1 is a schematic side view showing a transfer device of a battery-powered forklift according to an embodiment of the invention.

FIG. 2 is a sectional view taken along the line A-A in FIG. 1.

FIG. 3 is a sectional view showing a second embodiment and taken along the line B-B in FIG. 1.

### DETAILED DESCRIPTION OF THE PREFERRED EMBODIMENTS

Hereinafter, exemplary embodiments of the invention will be described in detail with reference to the accompanying drawings. However, the dimensions, materials, shapes, and relative arrangement of the constituents described in these embodiments are not used to limit the scope of the invention unless a particular description is made, and are merely examples of the invention.

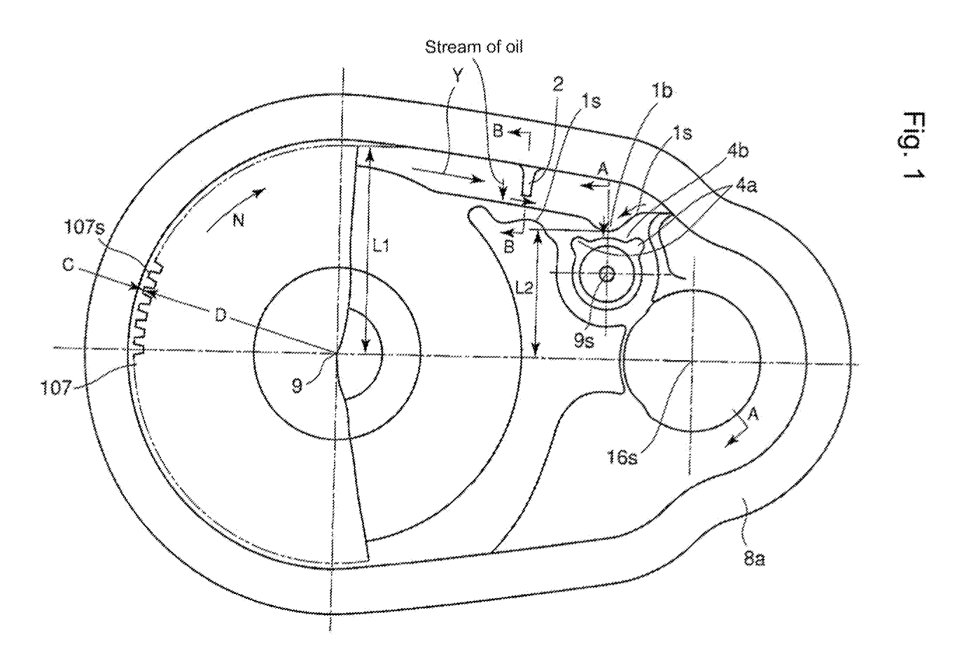

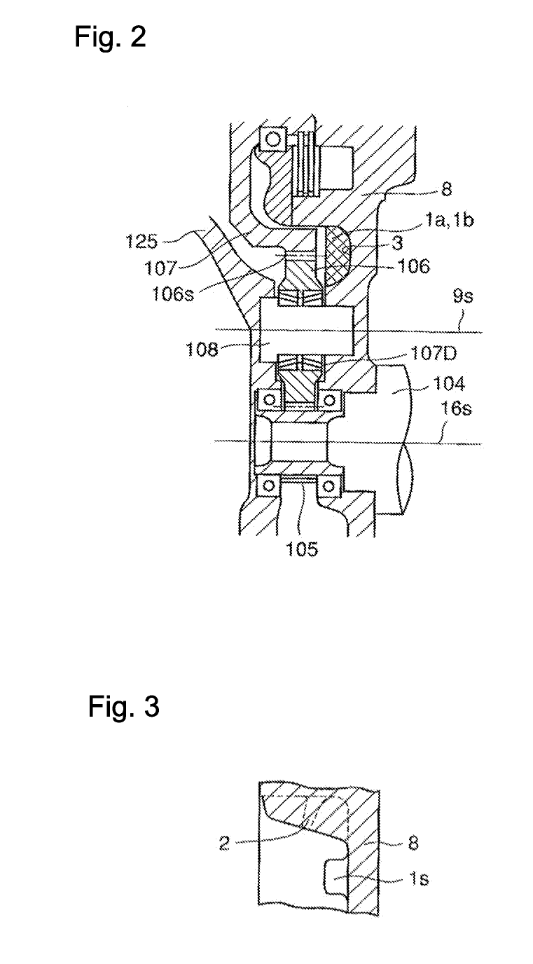

FIG. 1 is a schematic side view showing a transfer device of a battery-powered forklift according to an embodiment of the invention. FIG. 2 is a sectional view taken along the line A-A in FIG. 1. FIG. 3 is a sectional view taken along the line B-B in FIG. 1.

In addition, FIG. 1 only shows a configuration of a gear case 8 of a transfer drive device, where a first stage gear 105, an intermediate gear 106, and the like provided therein are not shown.

In FIGS. 1 and 2, in a gear case 8 of the transfer drive device, an output shaft 104 of a motor is fitted to the first stage gear 105 while being faucet-fitted to a hole provided in the gear case 8 of the transfer drive device.

The upper portion of the first stage gear 105 having an axis 16s meshes with the intermediate gear 106 having an axis 9s, and a third stage gear 107 having an axis 9 meshes with the lower portion of the intermediate gear 106. Accordingly, a first speed reduction of a rotation of the motor is performed.

Accordingly, in the transfer drive device, since the intermediate gear 106 having the axis 9s is located above the first stage gear 105 having the axis 16s and the third stage gear 107 having the axis 9, an oil splash feeding operation as in the background art is not performed.

### First Embodiment

Therefore, the invention has the following configuration.

In FIGS. 1 and 2, the upper portion of the first stage gear 105 having an axis 16s meshes with the intermediate gear 106 having an axis 9s, and a third stage gear 107 having an axis 9 meshes with the lower portion of the intermediate gear 106.

Accordingly, by means of the right direction rotation (a direction N in FIG. 1) of the third stage gear 107, oil in the lower space of the gear case 8 of the transfer drive device is pumped up by the movement of the gear teeth of the third stage gear 107 forming a minute gap C between the inner peripheral portion of the gear case 8 of the transfer drive device and a gear tooth tip 107s of the third stage gear 107.

The pumped oil scatters inside the gear case 8 of the transfer drive device as depicted by the arrow Y in FIG. 1 by the rotation of the third stage gear 107, is collected by a rib is formed in the upper portion of the intermediate gear 106 having the axis 9s along an inner surface 3 of the gear case 8 of the transfer drive device, and then is received in a recess (oil receiver) 1b surrounded by the rib 1s.

Since the oil receiver 1b is formed in such a manner that the rib 1s is enlarged into two ribs in a radial shape and the recess 1b is formed between the ribs 1s, it is possible to effectively seize the pumped oil in the oil receiver 1b formed as the recess 1b surrounded by two ribs 1s.

In addition, the upper portion of the intermediate gear 106 having the axis 9s is provided with bosses 4a and 4a and a recess (second oil receiver) 4b surrounded by the bosses 4a and 4a for the purpose of further receiving the pumped oil. As shown in FIG. 2, the pumped oil received therein is supplied to lubricate a bearing portion 107D of the intermediate gear 106 having the axis 9s.

Further, in this case, the vertical height L2 of the oil receiver 1b from the axes of the third stage gear 107 having the axis 9 and the first gear 105 having the axis 16s is set to be smaller than the radius D/2=L1 of the third stage gear 107, it is possible to smoothly supply the oil pumped from the outer periphery of the third stage gear 107 having the axis 9 to the lower oil receiver 1b.

Furthermore, as shown in FIG. 2, since a surface 3 of the bosses 4a and 4a of the oil receiver 1 and an inner surface 107 of the gear case 8 of the transfer drive device corresponding to the intermediate gear 106 having the axis 9s are formed as a common integral processing surface, it is possible to process the inner surface 3 of the bosses 4a and 4a of the oil receiver 1 together with the inner surface 107 of the gear case 8 of the transfer drive device, and thus to simplify the processing operation.

Accordingly, oil is pumped up by the centrifugal force in accordance with the rotation of the third stage gear 107, the pumped oil is received in the oil receiver 1 provided in the upper portion of the intermediate gear 106 having the axis 9s, and then the oil is supplied to lubricate the bearing portion 107D of the intermediate gear 10 having the axis 9s, thereby effectively and economically using the oil. Also, since a sufficient amount of oil is normally supplied to the upper intermediate gear 106 having the axis 9s, it is possible to prevent occurrence of problems such as poor lubrication and seizure of the gear train.

### Second Embodiment

Further, in a second embodiment of the invention, as shown in FIGS. 1 and 3, in addition to the first embodiment, by means of the rotation of the third stage gear 107, oil below the third stage gear 107 having the axis 9 and inside the gear case 8 of the transfer drive device is pumped up by the movement of the gear teeth 107s as in the first embodiment, and the pumped oil is discharged into the space above the intermediate gear 106 having the axis 9s and inside the gear case 8 of the transfer drive device. Also, the upper portion of the intermediate gear 106 is provided with a contact plate 2 which comes into contact with the pumped oil, and the turbulence of the oil inside the gear case 8 of the transfer drive device is suppressed by the contact plate 2.

With the above-described configuration, since the pumped oil comes into contact with the contact plate 2, the disturbance of the stream is removed, and tiny oil droplets are captured, thereby suppressing the turbulence. Subsequently, the pumped oil is supplied to the upper portion of the intermediate gear 106.

### INDUSTRIAL APPLICABILITY

According to the invention, in a gear train structure in which a gear case encases a first gear meshing with a second gear having a diameter smaller than that of the first gear, a sufficient amount of lubricant is normally supplied to the upper second gear. As a result, it is possible to provide a lubrication structure of a gear train encased in a gear case designed to prevent occurrence of problems such as poor lubrication and seizure of a bearing portion and a gear train.

1. A lubrication structure of a gear train encased in a gear case, comprising:
a first gear;
a second gear which is disposed above the first gear in the vertical direction and has a diameter smaller than that of the first gear; and
the gear case which encases the gear train of the first and second gears meshing with each other,
wherein the first gear is disposed so as to have a minute gap between the gear case and an outer diameter of the first gear, oil inside an oil chamber below the first gear is pumped up with a movement of gear teeth forming the minute gap by a rotation of the first gear, and the pumped oil is discharged into a space above the first gear and inside the gear case, and
wherein an oil receiver for receiving the pumped oil is provided in such a manner that a rib is provided in the upper portion of the second gear to receive the pumped oil, and a recess is surrounded by the rib, and the oil is supplied to lubricate a bearing portion of the second gear.

2. The lubrication structure of the gear train encased in the gear case according to claim 1,
wherein the oil receiver is provided in such a manner that the rib is enlarged into plural ribs in a radial shape, and the recess is provided between the plural ribs.

3. The lubrication structure of the gear train encased in the gear case according to claim 1,
wherein a vertical height L2 of the oil receiver from an axis of the first gear is set to be smaller than a radius L1 of the first gear.

4. The lubrication structure of the gear train encased in the gear case according to claim 1,
wherein a second oil receiver is provided in such a manner that plural bosses are provided in the upper portion of the bearing portion of the second gear, and a recess is provided between the plural bosses, and oil flowing out from the second oil receiver is supplied to the bearing portion.

5. The lubrication structure of the gear train encased in the gear case according to claim 1,
wherein an inner surface of a second oil receiver on the side of the second gear and a processing surface of an attachment boss of the second gear are formed as a common integral processing surface.

6. A lubrication structure of a gear train encased in a gear case, comprising:
a first gear;
a second gear which is disposed above the first gear in a direction perpendicular to an axis of the first gear and has a diameter smaller than that of the first gear; and
the gear case which encases the gear train of the first and second gears meshing with each other,
wherein oil inside an oil chamber below the first gear is pumped up with a movement of gear teeth forming a minute gap by a rotation of the first gear, and the pumped oil is discharged into a space above the first gear and inside the gear case, and
wherein the upper portion of the second gear is provided with a contact plate which comes into contact with the pumped oil, and turbulence of the oil inside the gear case is suppressed by the contact plate.
